(19) United States
(12) Patent Application Publication
(10) Pub. No.: US 2011/0093367 A1
(43) Pub. Date: Apr. 21, 2011

(54) METHOD, APPARATUS, AND COMPUTER PRODUCT FOR CENTRALIZED ACCOUNT PROVISIONING

(75) Inventor: David L. Stapleton, Plano, TX (US)

(73) Assignee: AT&T INTELLECTUAL PROPERTY I, L.P., Reno, NV (US)

(21) Appl. No.: 12/582,153

(22) Filed: Oct. 20, 2009

(51) Int. Cl. G06Q 10/00; G06Q 50/00

(52) U.S. Cl. 705/30; 726/6

(57) ABSTRACT

Method, apparatus, and computer products are provided for centralized account provisioning by an automated provisioning manager on a device. A logins application of a device is logged into. A request queue is accessed of the device. A ticket to provision is selected from the request queue of the device. Cells of the ticket are parsed to obtain details of a request on the ticket of the device. In response to obtaining details of the request, servers or applications are connected to in order to gather further data corresponding to the details. A corresponding function is called based on a request type of the details of the device, and the corresponding function is configured to the request of the request type. The account is provisioned by utilizing the corresponding function on the device.

### BACKGROUND

Exemplary embodiments relate to, but are not limited to, centralized account provisioning.

Organizations are keenly aware of the issues posed by the “information” age. Most organizations rely upon Information Technologies (“IT”) to do business. The rapid movement of information, expedited by the proliferation of intranets, extranets and the Internet, has elevated the strategic importance of IT. The infrastructure that contains the information needed to leverage resources, however, is often decentralized and difficult to access. While the possibilities for development and innovation have never been greater, the need to synchronize business strategies to ever-changing IT has become an issue on today's path to success.

Generally, today's businesses have tens or hundreds of resources. Each of these resources may be in different locations, with different access and control features. For example, if a business desires to add a new business partner, dozens of systems might need to be adjusted. Various personnel may be mobilized, who would then be responsible for implementing the changes. Some examples of these disparate tasks include configuring firewalls and virtual private networks (“VPNs”), electronically enrolling them in specific partner programs, providing new user, email and groupware accounts, as well as associating people with specific groups within applications. The entire setup process may be time intensive for management and IT network administrators.

### BRIEF SUMMARY

Exemplary embodiments include a method for centralized account provisioning by an automated provisioning manager on a device. A logins application of a device is logged into. Unassigned requests of the device are assigned to the centralized queue by the device. A request queue is accessed of the device. A ticket to provision is selected from the request queue of the device. Cells of the ticket are parsed to obtain details of a request on the ticket of the device. In response to obtaining details of the request, servers or applications are connected to in order to gather further data corresponding to the details. A corresponding function is called based on a request type of the details of the device, and the corresponding function is configured to the request of the request type. The account is provisioned by utilizing the corresponding function on the device.

Other systems, methods, apparatus, and/or computer program products according to embodiments will be or become apparent to one with skill in the art upon review of the following drawings and detailed description. It is intended that all such additional systems, methods, apparatus, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram in accordance with exemplary embodiments;

FIGS. 2-13 illustrate one implementation of the flow for the provisioning manager in accordance with exemplary embodiments;

FIG. 14 illustrates an example of a flow chart in which a provisioning manager obtains details including attributes from a ticket in accordance with exemplary embodiments;

FIGS. 15 and 16 illustrate other details in accordance with exemplary embodiments;

FIG. 17 illustrates a flow chart in accordance with exemplary embodiments;

FIG. 18 illustrates an example of a provisioning manager calling and provisioning accounts utilizing user functions in accordance to exemplary embodiments; and

FIG. 19 illustrates an example of a computer having elements utilized in implementing exemplary embodiments.

The detailed description explains exemplary embodiments, together with features, by way of example with reference to the drawings.

### DETAILED DESCRIPTION OF EXEMPLARY EMBODIMENTS

In the following detailed description, numerous specific details are set forth in order to provide a thorough understanding of the invention. However, it will be understood by those skilled in the art that the present disclosure may be practiced without these specific details. In other instances, well-known methods, procedures, components and circuits have not been described in detail so as not to obscure the present disclosure.

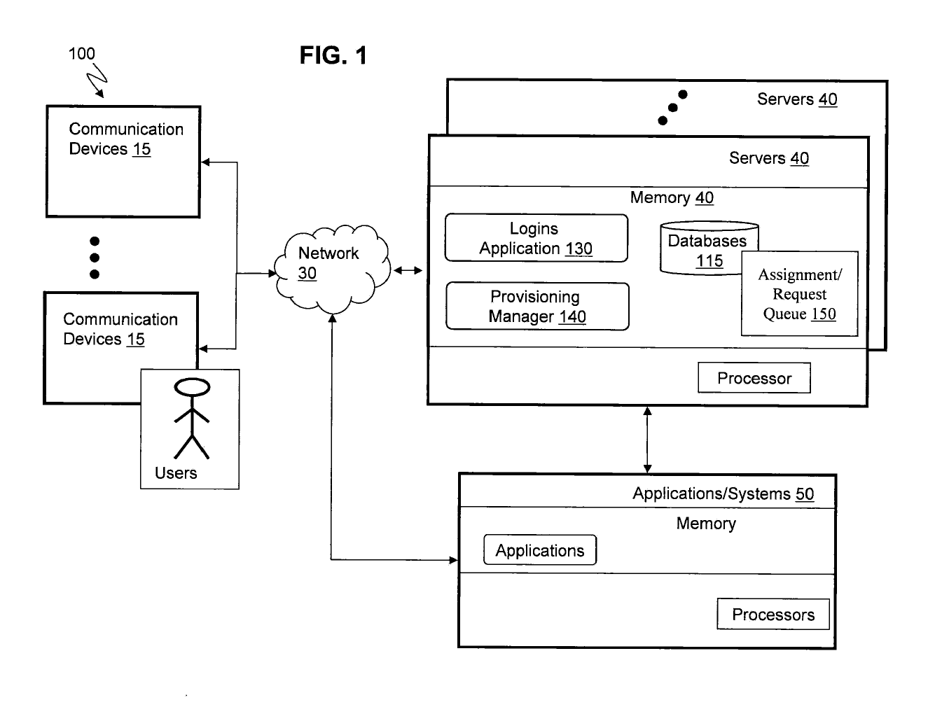

FIG. 1 illustrates a block diagram 100 in accordance with exemplary embodiments. In FIG. 1, one or more communication devices 15 are operative to communicate with one or more servers 40 over a network 30. The communication devices 15 may include, for example and without limitation, mobile telephones, landline telephones, smart telephones, soft telephones, personal digital assistants, set top boxes (STB), televisions (TV), game consoles, MP3 players, computers, and servers. For example, the communication device 15 may include, e.g., an IPHONE® by Apple®, a MOTOROLA® communication device, a BLACKBERRY® communication device by RIM, and any other kind of mobile communication device. The communication device 15 may include a user interface such as, e.g., a keyboard interface, a mouse, a touch screen, a track ball, etc., for inputting commands and operating the communication device 15.

Further regarding the network 30, the network 30 may include circuit-switched and/or packet-switched technologies and devices, such as routers, switches, hubs, gateways, etc., for facilitating communications. The network 30 may include wireline and/or wireless components utilizing, e.g., IEEE 802.11 standards for providing over-the-air transmissions of communications. The network 30 can include IP-based networks for communication between a customer service center and clients/users. The network 30 can manage multiple accounts as established by particular users. These accounts may then be used to provide access to services as described herein. Also, the network 30 may include wireline and/or wireless components utilizing standards, e.g., multimedia messaging services (MMS). The network 30 may include a multimedia messaging center (MMC), which implements the network side of multimedia messaging service (MMS) and makes it possible for an operator to offer multimedia messaging to mobile communication device users. The network 30 can include a managed IP and/or wireless network administered by a service provider, which can control bandwidth and quality of service for the communications discussed herein. The network 30 may be implemented in a wireless fashion, e.g., using wireless protocols and technologies, such as Wi-Fi®, WiMAX™, Bluetooth®, etc. The network 30 can also be a packet-switched network, such as a local area network, a wide area network, a metropolitan area network, an Internet network, or other similar types of networks. The network 30 may be a cellular communications network, a fixed wireless network, a wireless local area network (LAN), a wireless wide area network (WAN), a personal area network (PAN), a virtual private network (VPN), an intranet or any other suitable network, and the network 30 may include equipment for receiving and transmitting signals, such as a cell tower, a mobile switching center, a base station, and a wireless access point.

More regarding the network 30, the network 30 may include circuit-switched and/or packet-switched technologies and devices, such as routers, switches, hubs, gateways, etc., for facilitating communications. The network 30 may include wireline and/or wireless components utilizing, e.g., IEEE 802.11 standards for providing over-the-air transmissions of communications. The network 30 can include IP-based networks for communication between a customer service center and clients/users. The network 30 can manage multiple accounts as established by particular users. These accounts may then be used to provide access to services as described herein.

Referring still to FIG. 1, the servers 40 may include memory 40. The memory 40 may be a computer readable storage medium as discussed herein. A logins application 130 and a provisioning manager 140 may be separate software applications, numerous software applications working cooperatively, and/or a single software application having numerous components/modules.

The logins application 130 may, e.g., be a web-based application for providing end users (utilizing the communication device 15) a centralized method for requesting the creation, modification, deletion, and/or password reset for a wide array of personal system accounts for various applications and systems 50 and/or of databases 115. The applications and systems 50 represent numerous application and systems that users may need to access and that users may need accounts provisioned for. The number of requests from the communication devices 15 that pass through the logins application 130 web site is substantially large. Typically, these requests are routed to various teams (network administrators) and subsequently distributed to individuals (network administrators) for user account provisioning. In accordance with exemplary embodiments, the provisioning manager 140 is operative to centralize the thousands of requests that pass through the logins application 130 web site by employing the provisioning manager 140 as the account provisioning automation system in place of requiring the network administrators to provision accounts.

In exemplary embodiments, the provisioning manager 140 is operative to be an automated system that interfaces with the logins application 130 web site and the billing systems requested therein, such as, e.g., the system 50. The provisioning manager 140 is operative to run on a schedule and/or to run seven days a week from a particular start time to a particular end time. The provisioning manager 140 is operative to automate the provisioning of accounts as requested via logins application 130 by various users of the communication devices 15. The provisioning manager 140 is configured to be fully scalable and (software components) can be spread amongst multiple servers 40 to provision as many systems as necessary. The code executed by the provisioning manager 140 can be developed rapidly by the implementation of class inheritance and code reusability. In implementations of exemplary embodiments, the provisioning manager 140 may be integrated with the logins manager 130 as discussed herein.

The provisioning manager 140 is operative to interface with a ticketing system such as the logins application 130, and many other systems 50 such as billing systems. For example, the logins application 130 is the system in which requests, such as tickets, are submitted in order for employees, e.g., utilizing communication device 15, to request access to billing systems and any other type of system. AT&T® may refer to the logins application 130 system as MyLogins™. The logins application 130 receives information submitted by users of the communication device 15 to create or modify accounts, and after completing the account provisioning by the provisioning manager 140, the requests are marked completed with the username, password, and status message for each user by the provisioning manager 140.

The provisioning manager 140 is operative to also interface with many systems 50, such as billing systems. Each system serves as the target for each ticket and the target is the particular accounts and systems 50 in which users need account provisioning, which also include the removal of users. The provisioning manager 140 may access the billing system by utilizing Structured Query Language (SQL), Web graphical user interface (GUI), and/or the combination of both and other known techniques in the art.

The provisioning manager 140 is operative to utilize user classes and characteristics. The provisioning manager 140 is a background process invisible to users, utilizing the communication devices 15, who submit their requests through the logins application 130 web site. The provisioning manager 140 is configured to receive from the communication devices 15, e.g., via the logins application 130, various types of requests submitted by the user for account provisioning to systems 50, such as add, change, password reset, delete, and/or separated.

For example, the logins application 130 may receive an add request for a new hire employee. The manager of this employee (and/or the employee) submits a logins application 130 request to create him/her the appropriate account in the requested target applications and systems 50.

For a change and/or password reset request, an existing employee may submit a logins application 130 request to modify an existing account, add a new account, and/or even remove his/her account to/from the requested applications and systems 50. The existing employee may also submit to the logins application 130 a password reset request to a specified system, such as the applications and systems 50.

For a delete and/or separate/expired request, the manager of a terminated employee (or human resources) may submit a logins application 130 request to remove terminated employee's access from all systems, such as the applications and systems 50.

The provisioning manager 140 is operative to automatically provision each of the above requests for various types of systems and/or applications 50 that have been submitted via the logins application 130.

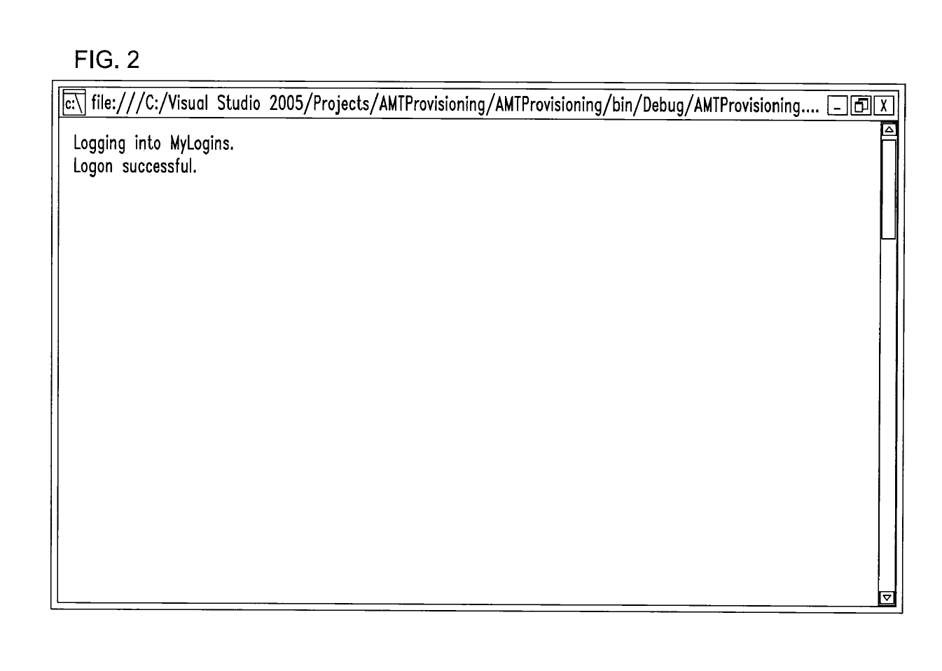

FIGS. 2-13 illustrate an implementation of the flow for the provisioning manager 140 in accordance with exemplary embodiments. The provisioning manager 140 works in cooperation with the logins application 130. FIGS. 2-13 depict example screenshots illustrating how the provisioning manager 140 (which may also named TinyTim™ in the screenshots) may display information while downloading and provisioning user accounts for applications and systems 50. The screenshots of FIGS. 2-13 are for explanation purposes and are not meant to be limiting.

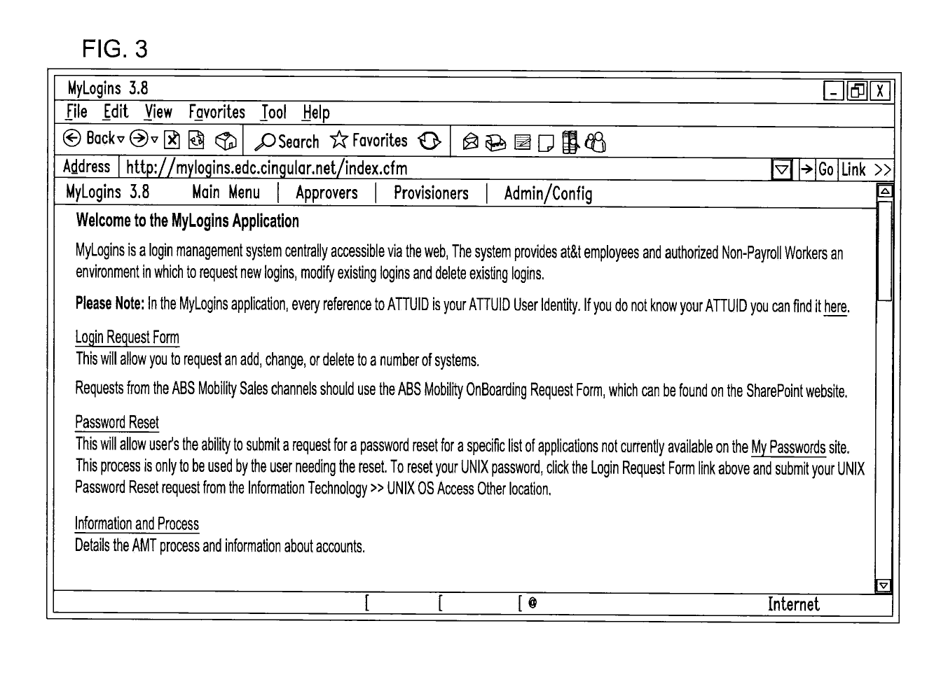

As seen illustrated in FIGS. 2 and 3, the provisioning manager 140 is operative to automatically connect to the logins application 130 web site, which may be named as MyLogins™ web site in the screen shots. If the provisioning manager 140 is prompted for its username and password by the logins application 130, the web page of the logins application 130 is updated with the credentials of the provisioning manager 140. The logins application 130 may utilize Global Logon technology, such that after the provisioning manager 140 has logged in once with its username and password, the provisioning manager 140 is not required to login thereafter.

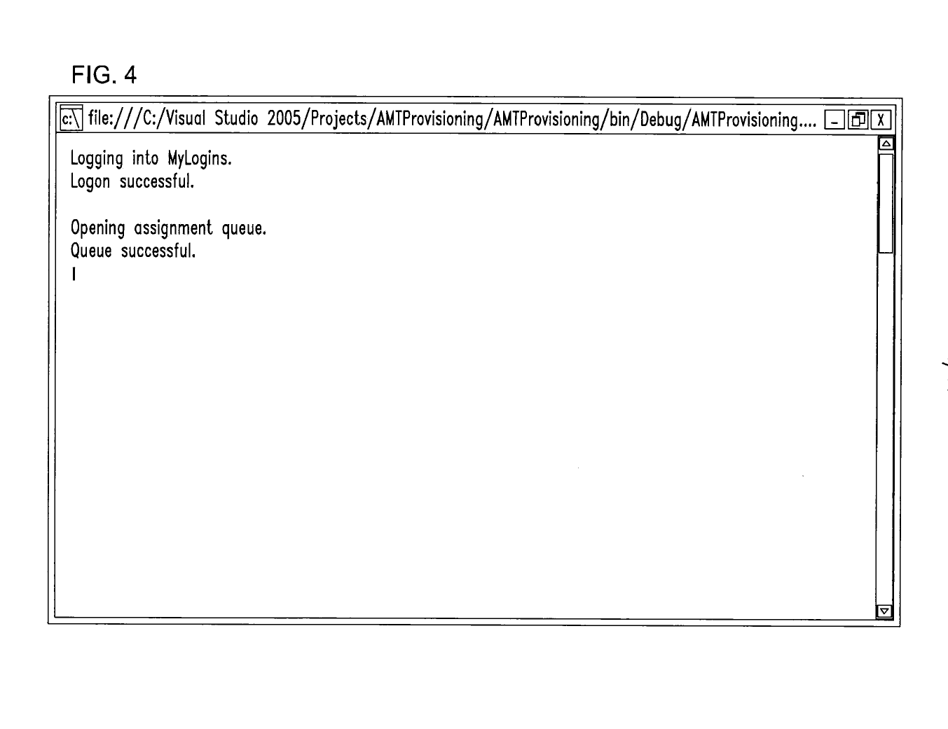

In the screenshot of FIG. 4, the provisioning manager 140 is operative to open its assignment/request queue, which contains all requests that the provisioning manager 140 has been assigned to provision. The requests in the assignment queue may have been submitted to the logins application 130 by users of the communication devices 15 requesting account provisioning, e.g., such as add, change, password reset, delete, and/or separated.

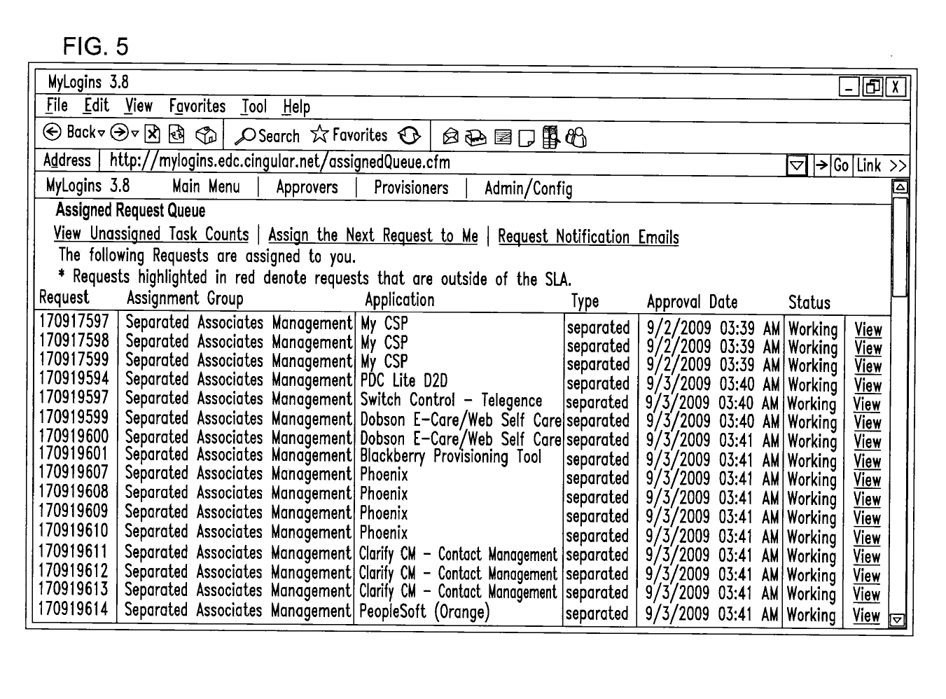

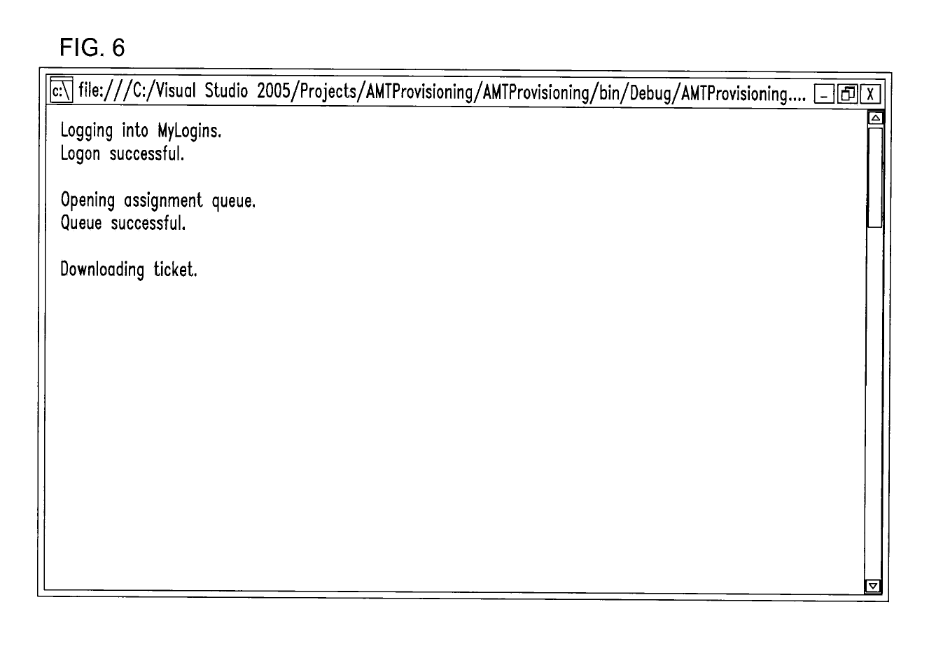

In the screenshots of FIGS. 5 and 6, the provisioning manager 140 is operative to open and iterate through the request queue in search for the first application/system 50 and request type that match what the provisioning manager 140 has been directed to process. The provisioning manager 140 may download a ticket that corresponds to the first application/system 50 and request type. The provisioning manager 140 may be configured to process a certain request type, such as separated (expired) first because an employee who is separated (expired) from the company for any reason no longer needs access to the numerous application and systems 50. If a former employee is designated as expired (e.g., meaning longer with the company) in the logins application 130 ticket, the provisioning manager 140

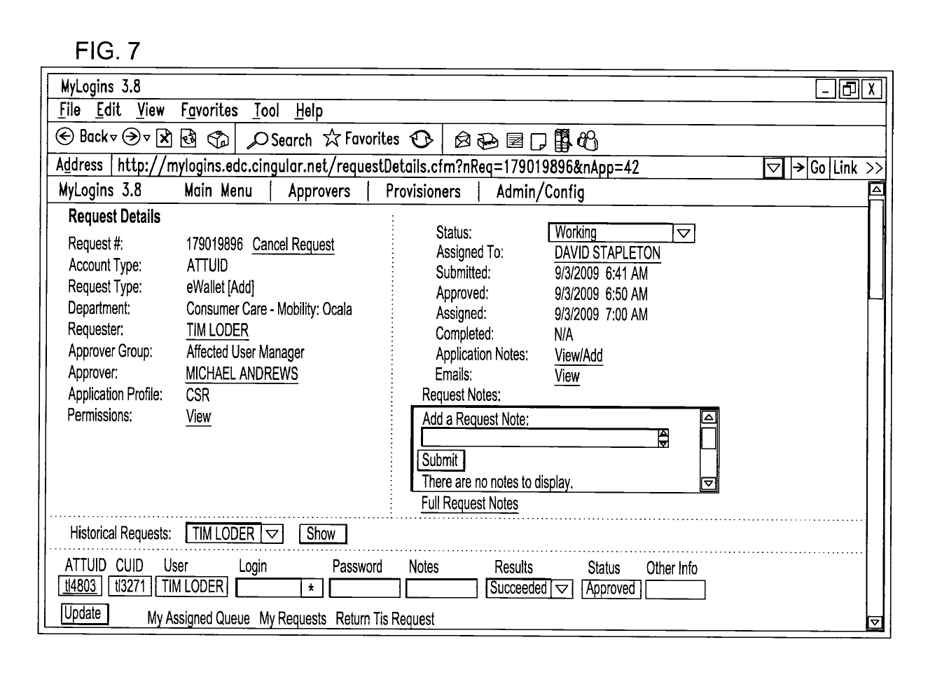

In this example, the provisioning manager 140 has been directed to process the application, e.g., eWallet, as shown in FIG. 7. In the screenshot of FIG. 7, the provisioning manager 140 is operative to open the request page that contains all information that is pertinent to the type of request and profile attributes, and all required information may be gathered from within the HTML by the provisioning manager 140 in FIG. 7.

To be accessible in the request queue for the provisioning manager 140, the logins application 130 is operative to receive one or more names of particular applications that need to be modified and/or created for the user. Also, to be accessible in the request queue for the provisioning manager 140, the logins application 130 may receive a user ID, such as ATTID, the user's email address, and/or the manager's email address. To be accessible in the request queue for the provisioning manager 140, the logins application 130 may also receive a profile selection such as finance profile, dealer profile, sales profile, business care profile, customer care profile, IT management profile, retail store manager profile, etc., and other profile attributes and the provisioning manager 140 is operative to extract details of the particular profile, e.g., from the database 115.

Another attribute accessible in the request queue for the provisioning manager 140 and selected via the logins application 130 may be a sales channel. In the logins application 130, a sales channel gives access to sale certain products and services, and the provisioning manager 140 is operative to extract the particular sales channel information for a product of service that has been selected for a user.

An additional attribute accessible in the request queue for the provisioning manager 140 and selected via the logins application 130 may be the location. In the logins application 130, the location may include a call center, care markets, direct sales call center, outsource call center, and the like. Further, in addition to selecting, e.g., a call center, the user may select a state such as Alabama call center, Texas collections center, etc.

Other attributes accessible in the request queue for the provisioning manager 140 and selected via the logins application 130 may include employment status. The employment statuses extractable by the provisioning manager 140 may include employee, contingent worker, vendor, and/or system ID. System ID indicates that this is a non-human account for a machine.

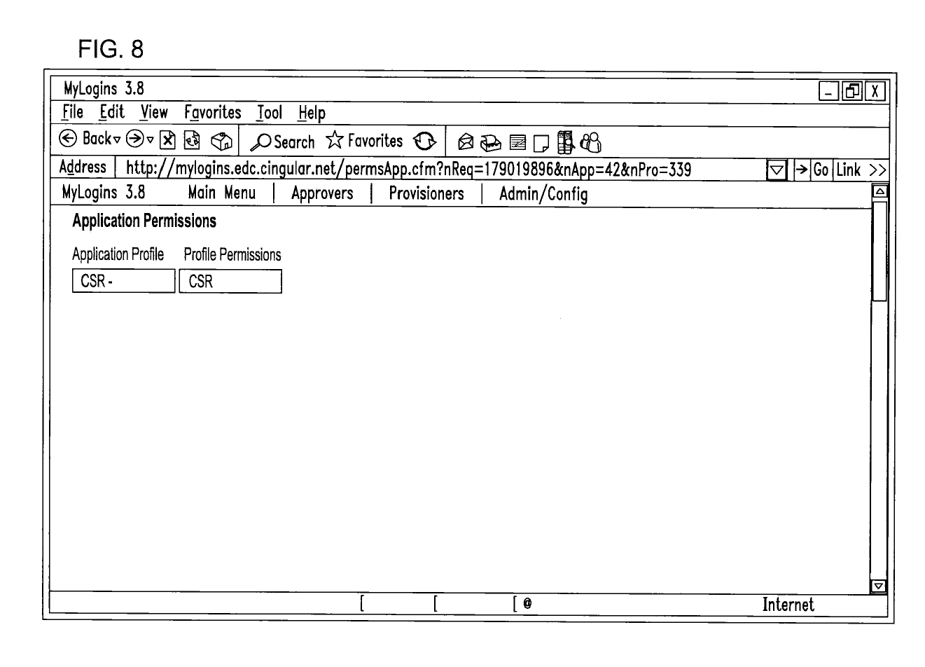

In FIG. 8, the provisioning manager 140 is operative to retrieve one or more profile attributes named, e.g., CSR, which can be in the database 115 and/or on different servers 40 and 50. If a different profile was on the ticket, the provisioning manager is operative to connect to other servers, such as servers 40 and 50, to gather information for the profile, and the profile may be a finance profile, dealer profile, sales profile, business care profile, customer care profile, IT management profile, retail store manager profile, etc. With regard to the CSR profile, the profile attributes in the CSR database may be permissions for the particular users desiring an account for eWallet and the CSR profile (or any other profile) may indicate additional requirements for any user requiring an account to be provisioned. In exemplary embodiments, a person utilizing the communication device 15 may input numerous users to be provisioned by the provisioning manager 140 for eWallet. The provisioning manager 140 is operative to retrieve each selected attribute and any other information that is provided in the request queue for the ticket.

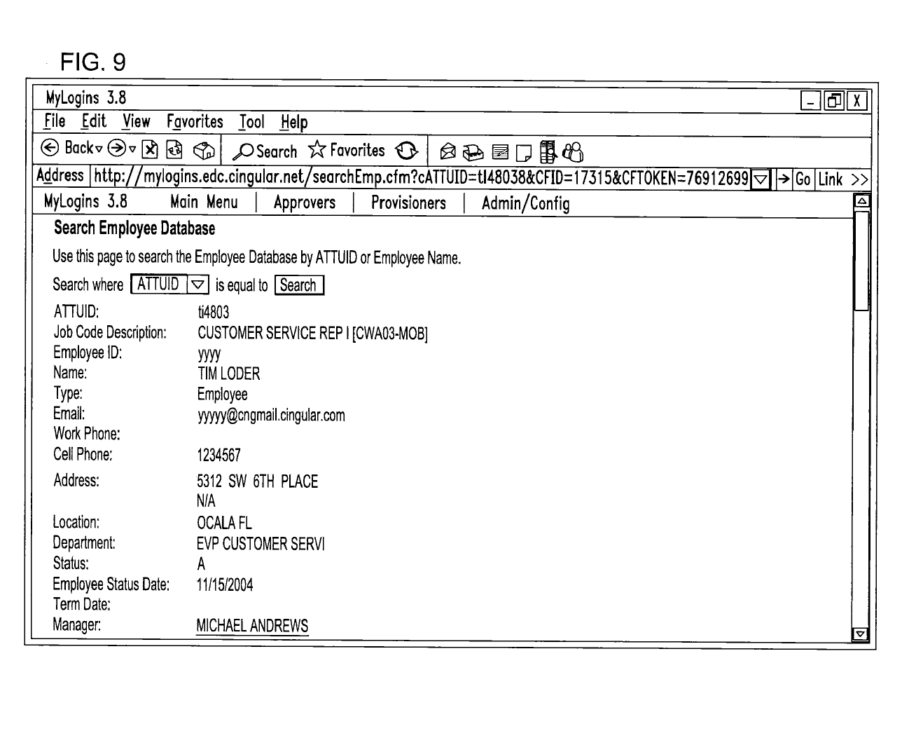

In the screenshot of FIG. 9, the provisioning manager 140 is configured to search for each user against the employee database, e.g., the database 115 and retrieve his/her information such as but not limited to employment status. For example, a vendor may not be permitted by the provisioning manager 140 to obtain access to eWallet (or other applications and/or accounts) while other users having different employment statuses are permitted.

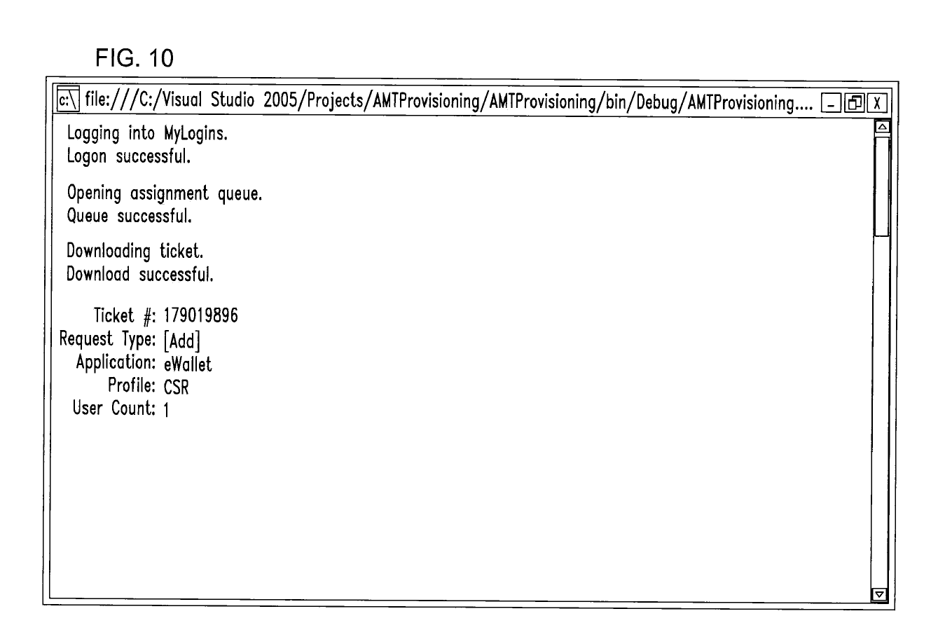

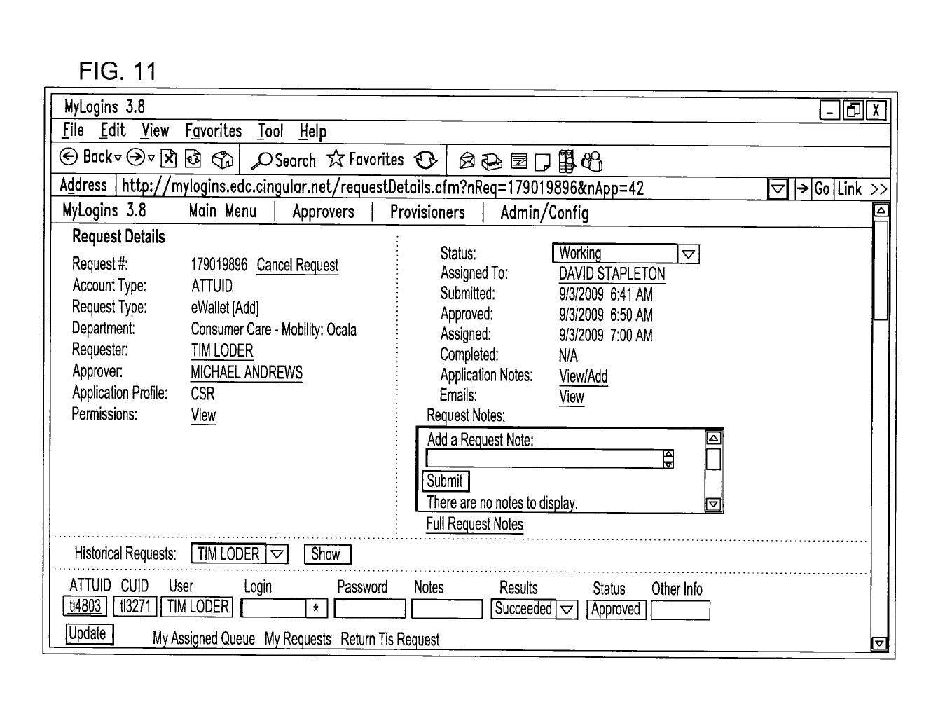

Now that all of the pertinent information has been gathered, the provisioning manager 140 is configured to display the fundamental information to the screen shown in FIG. 10 and return to the request's page as shown in FIG. 11. It is understood that the information displayed in FIGS. 10 and 11 is only for explanation purposes only. Although the user count is shown as 1, it is understood that a single ticket may have, e.g., 40 users to process; the provisioning manager 140 may be at user count 20 and have 20 more users to process before that particular ticket is completed (at user count 40).

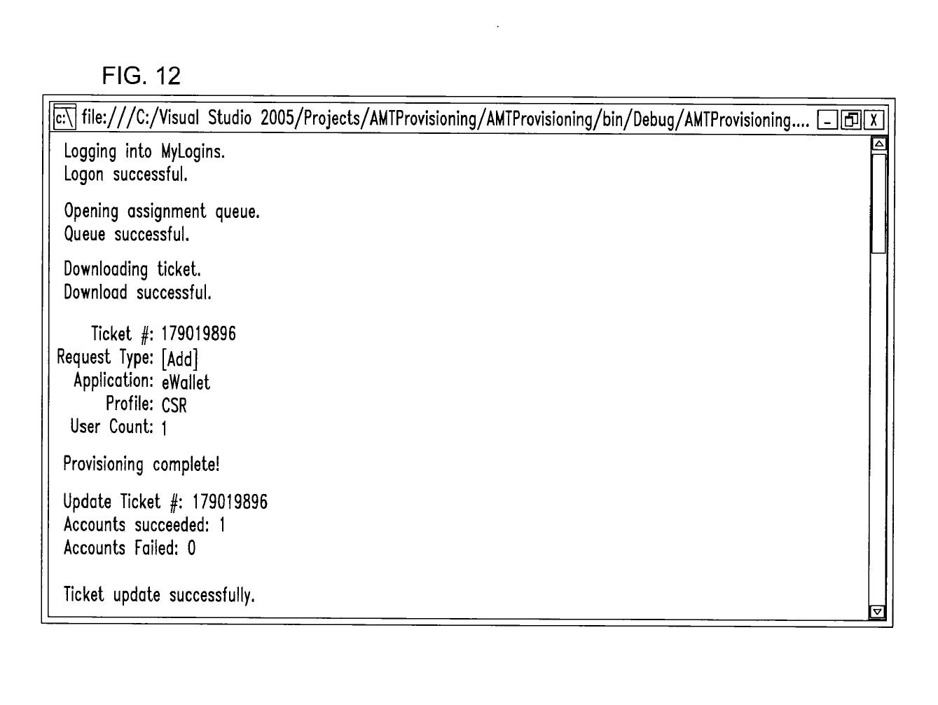

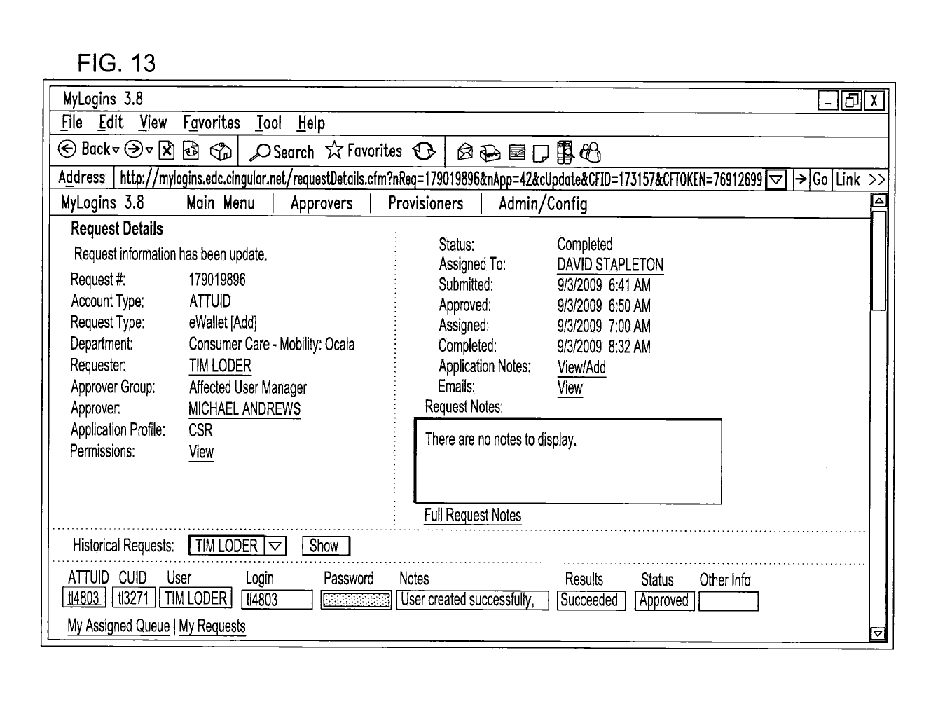

In FIGS. 12 and 13, the provisioning manager 140 is operative to provision each user in the target application (e.g., eWallet). In this example, the provisioning manager 140 created an account for the users in eWallet. After the provisioning is complete, the provisioning manager 140 is operative to update the request with the username, password, message, and result information (the password has been shaded for security purposes), as seen in FIGS. 12 and 13.

After the request has been updated by the provisioning manager 140 which continues until all the users, e.g., 40 users, have been provisioned, the provisioning manager 140 returns to the assignment/request queue and repeats the process of downloading tickets, provisioning accounts, and updating ticket information for other applications and systems besides the example eWallet. Once all requests have been completed, the provisioning manager 140 is operative to sleep until its next scheduled iteration. Although information has been shown in FIGS. 2-13 for explanation purposes, it is understood that more information be provided and exemplary embodiments are not meant to be limited.

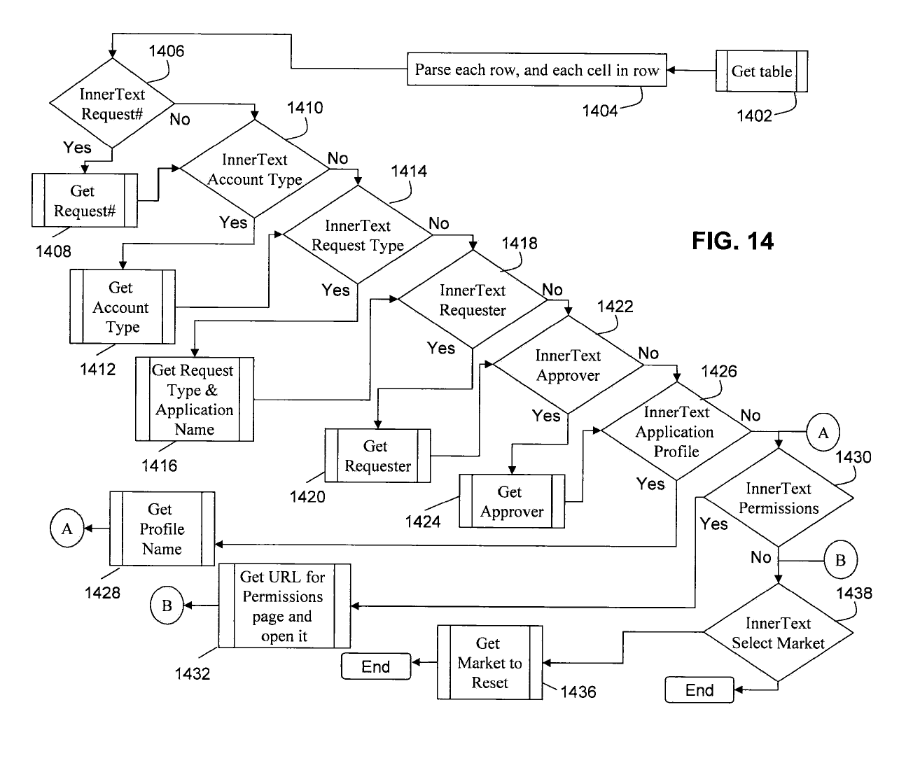

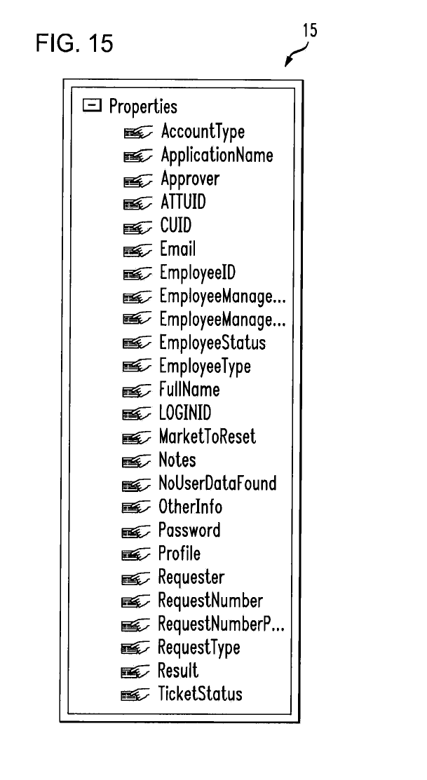

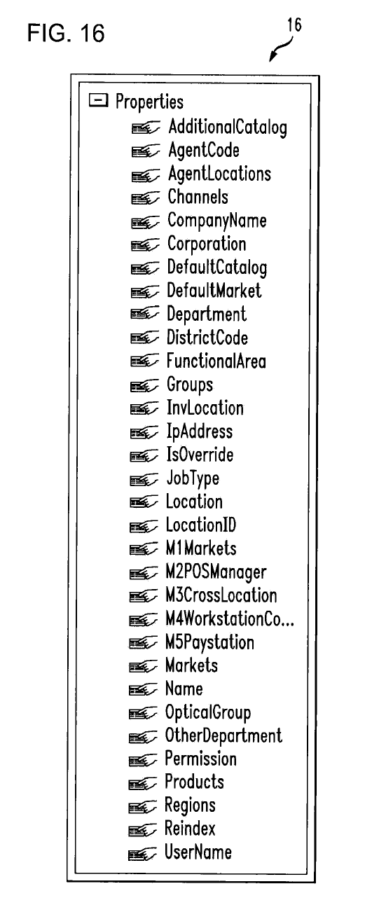

FIG. 14 illustrates an example of a flow chart 1400 in which the provisioning manager 140 obtains details including attributes for logins application 130 tickets in accordance with exemplary embodiments. The details may be identified in each ticket via the logins application 130. Additional details from a ticket in the request queue that may not be shown in the flow chart 1400 may be shown in FIGS. 15 and 16, and if any of the details are selected via the logins application 130, the provisioning manager 140 is operative to retrieve the data for each selected detail from the database 115 and/or applications and severs 50.

The provisioning manager 140 is operative to retrieve a table having information related to one or more users of a request submitted by the communication device 15 at operation 1402. The table may be, e.g., the request (assignment) queue, linked to the request queue, and/or combined with the request queue. The request queue and/or table may be stored in the database 115.

The provisioning manager 140 is operative to parse each row in the table and each cell in the rows to obtain information for provisioning the account at operation 1404. The ticket may have, e.g., 40 users and the provisioning manager 140 parses the rows and cells in the table for each user and continues until each user is provisioned.

At operation 1406, the provisioning manager 140 is operative to determine if the data in a cell is a request number at operation 1406. If Yes, the provisioning manager 140 is operative to retrieve the request number at 1408. Each ticket is assigned a request number by the logins application 130.

If No or if branching from operation 1408, the provisioning manager 140 is operative to determine if the data in a cell is an account type at operation 1410. If Yes, the provisioning manager 140 is operative to retrieve the account type at operation 1412.

If No or if branching from operation 1412, the provisioning manager 140 is operative to determine if the data in a cell is a request type at operation 1414. If Yes, the provisioning manager 140 is operative to retrieve request type and application name at operation 1416. The request type may include add, change, password reset, delete, and/or separated and the application name may be, e.g., eWallet.

If No or if branching from operation 1416, the provisioning manager 140 is operative to determine if the data in a cell is a requester at operation 1418. If Yes the data is a requester, the provisioning manager 140 is operative to retrieve the requester at operation 1420. The requester may be the user himself or herself that is in need of the account, and/or the requester may be the manager of the user in need of the account.

If No or if branching from operation 1420, the provisioning manager 140 is operative to determine if the data in a cell is an approver at operation 1422. If Yes the data is the approver, the provisioning manager 140 is operative to retrieve the approver at operation 1424. For some accounts, an approver, such as a manager, may need to indicate that the approver approves of the account provisioning for the particular user, and the provisioning manager 140 is operative to retrieve the approved and/or denied status for each user in need of the account.

If No or if branching from operation 1424, the provisioning manager 140 is operative to determine if the data in a cell is application profile at operation 1426. If Yes, the provisioning manager 140 is operative to retrieve the profile name at operation 1428. There are many profile names as discussed herein. The provisioning manager 140 is operative to obtain each profile name associated with the user and then retrieve from a computing device (such as the servers 40 and 50) the profile that has been indicated. Example profiles may include a finance profile, dealer profile, sales profile, business care profile, customer care profile, IT management profile, and retail store manager profile and each profile may reside on a different computing device, such as servers 40 and 50 that need to be communicated to by the provisioning manager 140.

If No or branching from operation 1428, the provisioning manager 140 is operative to determine if the data in a cell is a requester at operation 1430. If the data is a requester, the provisioning manager 140 is operative to retrieve a uniform resource locator (URL) for a permissions page and open the URL at operation 1432.

If No or if branching from operation 1432, the provisioning manager 140 is operative to determine if the data in a cell is a select market at operation 1434. If Yes, the provisioning manager 140 is operative to retrieve market to reset at operation 1436.

If No or if branching from operation 1436 the flow ends.

In addition to the details checked for and retrieved by the provisioning manager 140 in FIG. 14, the provisioning manager 140 may also check for and retrieve other ticket details 1500 as shown in FIG. 15 and ticket details 1600 as shown in FIG. 16.

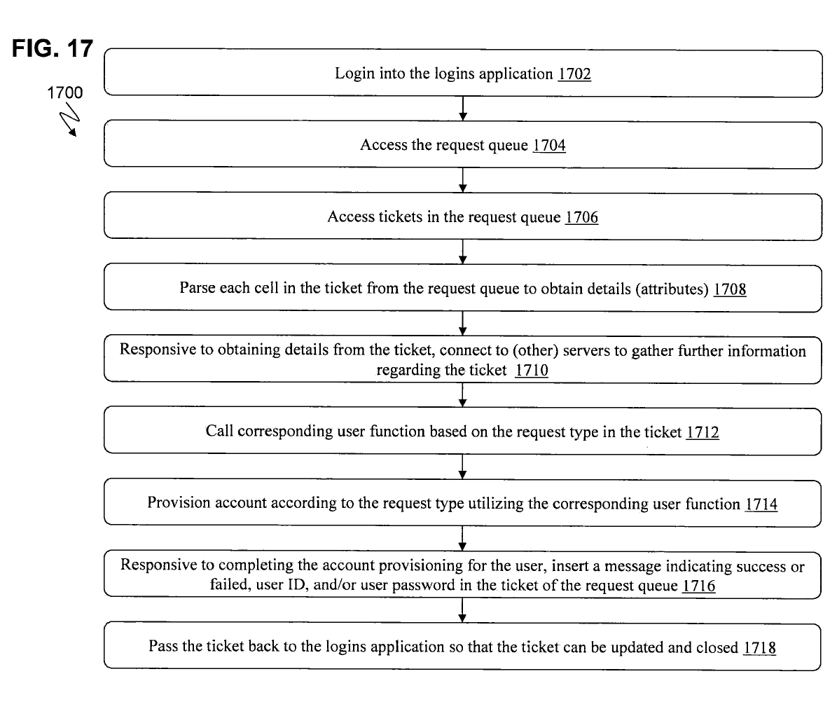

FIG. 17 illustrates a flow chart in accordance with exemplary embodiments.

The provisioning manager 140 is operative to login into the logins application 130 as shown in FIGS. 2 and 3 at 1702. The provisioning manager 140 may connect to a web interface of the logins application 130 and inputs credentials such as a username and password. Alternatively and/or additionally, the provisioning manager 140 may provide its credential by utilizing a public key and private key authentication with the logins application 130. Also, in exemplary embodiments, the provisioning manager 140 and the logins application 130 may be an integrated software application, e.g., having many software components. Although the provisioning manager 140 and the logins application 130 are illustrated in the servers 40, in exemplary embodiments the provisioning manager 140 and the logins application 130 may reside on different servers 40. The provisioning manager 140 may be scheduled to login into the logins application 130 at scheduled times and/or periodically. For example, the provisioning manager 140 may login to the logins application 130 in the morning (e.g., 7 AM) and logout in the evening (e.g., 9 PM).

The provisioning manager 140 is operative access the request queue 150 of, e.g., the database 115 at 1704. In an implementation of exemplary embodiments, the provisioning manager 140 may retrieve certain requests from a network administrator request queue and assign the requests to the requests queue 150 of the provisioning manager 140. Alternatively and/or additionally, the requests may automatically be assigned to the requests queue of the provisioning manager 140 without the provisioning manager 140 having to retrieve requests from the administrator's request queue. Also, there may be certain applications/servers 50 that the provisioning manager 140 can process, and the provisioning manager 140 is operative to retrieve and assign to itself those particular requests from the network administrator request queue, while the provisioning manager 140 leaves the applications that the provisioning manager 140 cannot process in the network administrator request queue to be provisioned by the network administrator.

The provisioning manager 140 is operative to access the tickets in the request queue 150, which may be a table, at 1706. The request queue 150 comprises numerous tickets, and each ticket contains information regarding the request submitted by the users of the communication device 15. In an implementation of exemplary embodiments, the provisioning manager 140 may be configured to first retrieve tickets requesting accounts for certain application, such as eWallet, before provisioning other applications.

The provisioning manager 140 is operative to parse each cell in the ticket of a user to obtain details (attributes) of the ticket at 1708. The provisioning manager 140 is operative to obtain any of the information discussed herein and e.g., illustrated in FIGS. 15 and 16. Some information, such as name, user ID, application name, account type, name of profile, etc., may be on the ticket.

In response to obtaining details from the ticket, the provisioning manager 140 is operative to connect to other servers 40 and 50 to gather further information based the ticket at 1710. For example, in response to the provisioning manager 140 determining that a profile name is an attribute in the ticket, the provisioning manager 140 is operative to search for and locate the named profile, which may be located on a different computing device from the provisioning manager 140. For example, the named profile such as CSR may be located on a server 40 that is different from the server 40 on which the provisioning manager 140 resides. When the provisioning manager 140 locates the different server 40, the provisioning manager 140 is operative to gather all the profile data for the named profile, so that the gathered profile data can be utilized in provisioning an account for the user. The provisioning manager 140 may have to locate and connect to various databases, such as the databases 115, various applications/systems 50, and/or other storage devices (having a computer readable medium) to obtain additional information that is not on the ticket that may be needed to provision the account for the user. For example, one or more tickets may need approval from a manager and the approval may be stored in the database 115, for example, on a different server 40; the provisioning manager 140 is operative to locate the manager approval database and find the entry approving or rejecting the user account provisioning that corresponds to the current user.

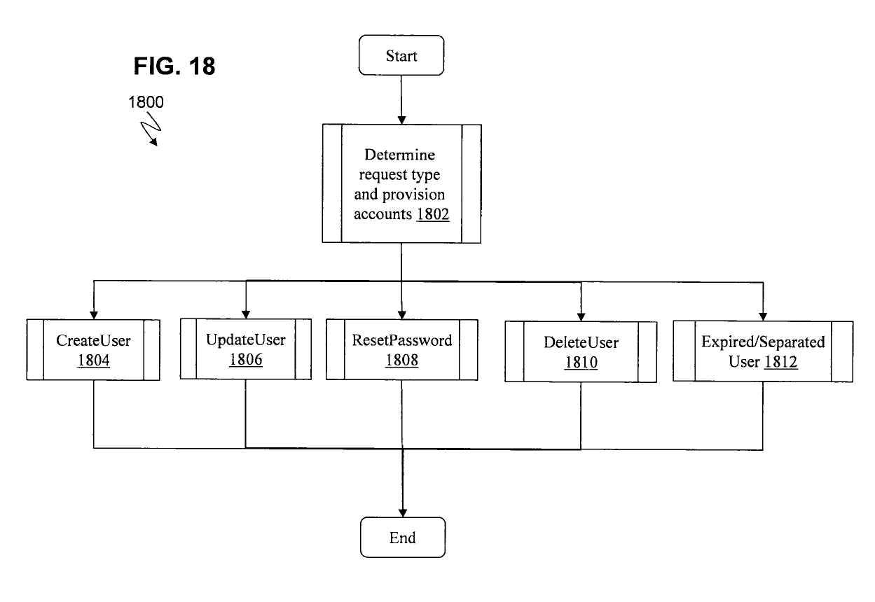

When processing all of the information for the user, the provisioning manager 140 is operative to call a corresponding user function based on the request type in the ticket at 1712. The request types may be to add users, change users, reset the password for users, and/or delete users that may be separated. The provisioning manager 140 has different user functions that correspond to each request type and can retrieve the corresponding user function configured to perform the selected request type. The each of the corresponding user functions may be integrated into the provisioning manger 140. Also, the provisioning manager may perform a lookup to determine if the user already exists, and the user can be processed differently by the provisioning manager 140, e.g., to insert the new user or update the user. As discussed below, FIG. 18 illustrates an example of the provisioning manager 130 calling and provisioning user functions in according to exemplary embodiments.

Using all obtained data and/or details related to the ticket, the provisioning manager 140 is operative to provision the account for the user according to the request type utilizing the corresponding user function at 1714. For provisioning an account having a request to add users, the provisioning manager 104 is operative to add one or more users the particular account as requested in the ticket using the details of the ticket and the further information obtained by connecting to other applications and servers.

In response to the provisioning manager 140 completing the account provisioning for the user, the provisioning manager 140 is operative to provide and insert a message indicating success or failed, user ID, and/or user password in the corresponding ticket of the request queue 150 at 1716. Also, the provisioning manager 140 may add notes in a notes field of the ticket.

The provisioning manager 140 is operative to pass the ticket back to the logins application 130 so that the ticket can be updated and closed at 1718. The provisioning manager 140 continues this process for each user on the ticket.

In response to the provisioning manager 140 completing the account provisioning for each user on the single ticket, the provisioning manager 140 is operative to return to the request queue and grab another ticket.

Now turning to FIG. 18, FIG. 18 illustrates an example of the provisioning manager 130 calling and provisioning user functions in according to exemplary embodiments.

The provisioning manager 130 is operative to determine the request type of the ticket at 1802. Based on the request type of the ticket for the user, the provisioning manager 130 is operative to call functions and utilize functions including a create user function 1804, update user function 1806, reset user password function 1808, delete user function 1810, and/or expired/separated user function 1812.

The create user function 1804 is configured to create new accounts for each user on the ticket for each application and system 50 identified on the ticket, and the users on the tickets are new users for the particular account.

The update user function 1806 is configured to update existing users which may already have access to some accounts but need access to other accounts (e.g., applications and systems 50 that may be for billing systems, customer care accounts, etc.).

The reset user password function 1808 is configured to reset the password for each user submitted on the ticket for each account identified, and the accounts may be for many different applications and servers 50. The ticket may have numerous accounts identified and the reset password function 1808 is configured to reset the password for account and provide a new password.

The delete user function 1810 is configured to delete users from having access to one or more applications and systems 50 which may be for one or more accounts.

The expired/separated user function 1812 is configured to remove the users from having access to every application and system 50 which removes the users from all accounts as identified on the ticket. For example, the expired user function 1812 is for users who have left the company and/or who are being terminated. The expired user function 1812 searches for each user in the target application as identified on the ticket so that the users are then removed from having access to each target application and servers 40 and 50.

It is understood by one skilled in the art that each element such as the devices, servers, software, application, cards, modules, systems, interfaces, adapters, networks, controllers, computers, infrastructure, etc., described in the present disclosure contains all the necessary hardware, software, and/or firmware to operate and function as discussed herein in accordance with exemplary embodiments.

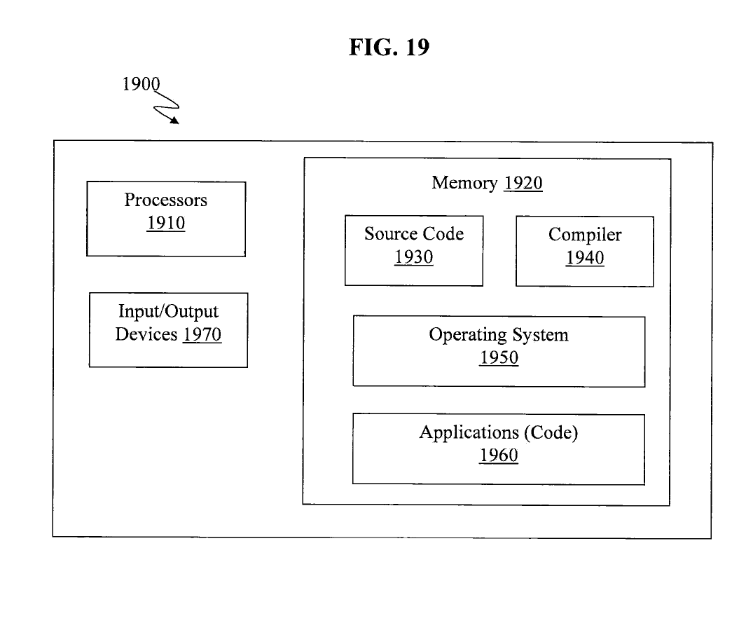

FIG. 19 illustrates an example of a computer 1900 having one or more elements that may be utilized in implementing the communication device 15, the servers 40, and/or the applications/servers 50 in accordance with exemplary embodiments. The computer 1900 includes, but is not limited to, PCs, workstations, systems, laptops, PDAs, palm devices, servers, mobile devices, communication devices, cell phones, computer systems, set top boxes (STB), televisions (TV), game consoles, MP3 players, and the like. The computer 1900 may include processors 1910, memory 1920, and one or more input and/or output (I/O) 1970 devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 1910 is a hardware device for executing software that can be stored in the memory 1920. The processor 1910 can be virtually any custom made or commercially available processor, a central processing unit (CPU), a data signal processor (DSP), or an auxiliary processor among several processors associated with the computer 1900, and the processor 1910 may be a semiconductor based microprocessor (in the form of a microchip) or a macroprocessor.

The memory 1920 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.), which may be considered as a computer readable medium. Moreover, the memory 1920 may incorporate electronic, magnetic, optical, and/or other types of storage media. Note that the memory 1920 can have a distributed architecture, where various components are situated remote from one another, but can be accessed by the processor 1910.

The software in the memory 1920 may include one or more separate programs, each of which comprises an ordered listing of executable instructions for implementing logical functions. In the example illustrated in FIG. 19, the software in the memory 1920 includes a suitable operating system (O/S) 1950, compiler 1940, source code 1930, and one or more applications 1960 (or modules) of the exemplary embodiments.

The operating system 1950 controls the execution of other computer programs, and provides scheduling, input-output control, file and data management, memory management, and communication control and related services. It is contemplated by the inventors that the application 1960 for implementing exemplary embodiments is applicable on all other commercially available operating systems.

The application 1960 may be a source program, executable program (object code), script, or any other entity comprising a set of instructions to be performed. When a source program is to be executed, then the program is usually translated via a compiler (such as the compiler 1940), assembler, interpreter, or the like, which may or may not be included within the memory 1920, so as to operate properly in connection with the O/S 1950. Furthermore, the application 1960 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 1970 may include input devices such as, for example but not limited to, a mouse, keyboard, scanner, microphone, remote controller, camera, biometric input device(s), a vibrator device for non-audible alert, etc. Furthermore, the I/O devices 1970 may also include output devices, for example but not limited to, a printer, display, speaker, etc. Also, the I/O devices 1970 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 1970 include may include modems, gateways, receivers, transmitters, transceivers, etc. for communicating over a communications network.

When the computer 1900 is in operation, the processor 1910 is configured to execute software stored within the memory 1920, to communicate data to and from the memory 1920, and to generally control operations of the computer 1900 pursuant to the software. The application 1960 and the O/S 1950 are read, in whole or in part, by the processor 1910, perhaps buffered within the processor 1910, and then executed.

When the application 1960 is implemented in software, it should be noted that the application 1960 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 1960 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, computer programs tangibly embodied on a computer-readable medium can be stored, communicated, propagated, or transported for use by or in connection with the instruction execution system, apparatus, or device.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 1960 is implemented in hardware, the application 1960 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer such as the computer 1900, the computer becomes an apparatus for practicing the exemplary embodiments. The exemplary embodiments can also be in the form of computer program code, for example, whether stored in a storage medium, loaded into and/or executed by a computer. When the computer program code is loaded into an executed by a computer, the computer becomes an apparatus for practicing the exemplary embodiments. When implemented on a general-purpose microprocessor, the computer program code segments configure the microprocessor to create specific logic circuits. It is understood that computer program code can be transmitted over some transmission medium, loaded into and/or executed by a computer, or transmitted over some transmission medium, such as over electrical wiring or cabling, through fiber optics, or via electromagnetic radiation.

While features have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the present disclosure without departing from the essential scope thereof. Therefore, it is intended that the present disclosure not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for centralized account provisioning by an automated provisioning manager on a device, comprising:
logging into a logins application of a device;
accessing a request queue of the device;
selecting a ticket to provision from the request queue of the device;
parsing cells of the ticket to obtain details of a request on the ticket of the device;
in response to obtaining details of the request, connecting to servers or applications to gather further data corresponding to the details of the device;
calling a corresponding function based on a request type of the details of the device, the corresponding function being configured to the request of the request type; and
provisioning the account utilizing the corresponding function of the device.

2. The method of claim 1, wherein in response to the request type being create one or more user accounts on the ticket, the corresponding function is a create user function.

3. The method of claim 1, wherein in response to the request type being update one or more users accounts on the ticket, the corresponding function is an update user function.

4. The method of claim 1, wherein in response to the request type being reset a password for one or more user accounts, the corresponding function is a reset user password function.

5. The method of claim 1, wherein in response to the request type being delete one of more user accounts, the corresponding function is a expire user function.

6. The method of claim 1, wherein in response to the request type being one or more users are terminated from a company, the corresponding function is expired user function.

7. The method of claim 1, wherein accessing the request queue of the device comprises a provisioning manager parsing the request queue to determine requests assigned to the provisioning manager; and
wherein the provisioning manager is operative to reassign to a provisioning manager request queue the requests assigned to the provisioning manager.

8. The method of claim 1, wherein the request queue is assigned to a network administrator for provisioning accounts;
wherein a provisioning manager is operative to automatically remove requests from the request queue assigned to the network administrator and reassign the removed requests to a provisioning manager request queue;
wherein requests remaining in the request queue are configured to be provisioned by the network administrator; and
wherein the provisioning manager is operative to provision accounts for requests reassigned to the provisioning manager request queue.

9. The method of claim 1, wherein connecting to servers or applications to gather further data corresponding to the details comprises a provisioning manager operative to search for and locate the applications and servers that contain data to provision the account; and
wherein the applications and servers are different from the device.

10. An device, comprising:
software configured to centralize account provisioning by an automated provisioning manager coupled to memory;
a processor responsive to computer-executable instructions of the software and operative to:
login to a logins application of a device;
access a request queue of the device;
select a ticket to provision from the request queue of the device;
parse cells of the ticket to obtain details of a request on the ticket of the device;
in response to obtaining details of the request, connect to servers or applications to gather further data corresponding to the details;
call a corresponding function based on a request type of the details of the device, the corresponding function being configured to the request of the request type; and
provision the account utilizing the corresponding function of the device.

11. The device of claim 10, wherein in response to the request type being create one or more user accounts on the ticket, the corresponding function is a create user function.

12. The device of claim 10, wherein in response to the request type being update one or more users accounts on the ticket, the corresponding function is an update user function.

13. The device of claim 10, wherein in response to the request type being reset a password for one or more user accounts, the corresponding function is a reset user password function.

14. The device of claim 10, wherein in response to the request type being delete one of more user accounts, the corresponding function is a expire user function.

15. The device of claim 10, wherein in response to the request type being one or more users are terminated from a company, the corresponding function is expired user function.

16. The device of claim 10, wherein accessing the request queue of the device comprises parsing the request queue to determine requests assigned to a provisioning manager; and
wherein the provisioning manager is operative to reassign to a provisioning manager request queue the requests assigned to the provisioning manager.

17. The device of claim 10, wherein the request queue is assigned to a network administrator for provisioning accounts;
wherein a provisioning manager is operative to automatically remove requests from the request queue assigned to the network administrator and reassign the removed requests to a provisioning manager request queue;
wherein requests remaining in the request queue are configured to be provisioned by the network administrator; and
wherein the provisioning manager is operative to provision accounts for requests reassigned to the provisioning manager request queue.

18. The device of claim 1, wherein the provisioning manager is operative to prioritize which requests to select first based on a requested application or server on each ticket in the provisioning manager request queue; and
wherein after the provisioning manager provisions accounts for the requested application or server that is prioritized to be selected first, the provisioning manager is operative to select other applications or servers for provisioning accounts.

19. The device of claim 10, wherein connecting to servers or applications to gather further data corresponding to the details comprises a provisioning manager operative to search for and locate the applications and servers that contain data to provision the account; and
wherein the applications and servers are different from the device.

20. A computer program product, tangibly embodied on a computer readable storage medium, the computer program product including instructions for causing a computer to execute a method for centralized account provisioning by an automated provisioning manager, comprising:
logging into a logins application;
accessing a request queue;
selecting a ticket to provision from the request queue;
parsing cells of the ticket to obtain details of a request on the ticket;
in response to obtaining details of the request, connecting to servers or applications to gather further data corresponding to the details;
calling a corresponding function based on a request type of the details of the device, the corresponding function being configured to the request of the request type; and
provisioning the account utilizing the corresponding function.
